(19) United States
(12) Patent Application Publication
(10) Pub. No.: US 2005/0027450 A1
(43) Pub. Date: Feb. 3, 2005

(54) Altitude aiding in a satellite positioning system

(76) Inventors: Geoffrey F. Cox, Camden, ME (US); Lionel J. Garin, Palo Alto, CA (US); Makarand S. Phatak, Sunnyvale, CA (US)

Correspondence Address: The Eclipse Group, 10453 Raintree Lane, Northridge, CA, 91326, US

(21) Appl. No.: 10/633,488

(22) Filed: Aug. 1, 2003

(51) Int. Cl. G01S 1/00

(52) U.S. Cl. 701/213; 342/357.08

(57) ABSTRACT

A satellite position system with a plurality of satellites transmitting spread spectrum signals to a satellite position system receiver that is able to determine location using three spread spectrum signals and a polynomial surface fit to digital altitude data that approximates the altitude of the satellite position system receiver.

### BACKGROUND OF THE INVENTION

1. Field of the Invention

This invention relates generally to satellite positioning system receiver and more practically to altitude aided satellite position receiver.

2. Related Art

Satellite positioning systems (SATPS) have been developed that enable SATPS receivers to determine a location upon receiving a SATPS spread spectrum signal from a plurality of satellites. An example of a SATPS is the Global Positioning Satellite (GPS) system maintained by the United States Government. A SATPS receiver must acquire four satellites in order to determine the location (latitude, longitude and altitude) of the SATPS receiver. However, in urban and rural indoor or outdoor environments, fewer than the required satellites may be acquired. Further, strong signal shading and signal fading may adversely affect a SATPS receiver ability to acquire the satellites. If four satellites are acquired, then a three-dimensional location may be determined. If three satellites are acquired, then a two-dimensional location (latitude and longitude) may be determined if altitude is known. Accurate two-dimensional location with three satellites is further impacted if the altitude is not adequately known, for example, when the SATPS receiver is used in a region of uneven elevation, such as in the mountains. One approach to assist with location determination if three satellites are acquired employs an algorithm that uses the last known altitude calculated from four acquired satellites. However, the more the altitude of the SATPS receiver has changed from the last known altitude, the greater the error that results in the location of the SATPS receiver location determination.

Therefore, there is a need for methods and systems for determining the location of a SATPS receiver when only three satellites are acquirable, that overcomes the many disadvantages set forth above and others previously experienced.

### SUMMARY

Systems consistent with the present invention provide an approach to determine location in a SATPS when only three SATPS satellites are acquired with the use of digital altitude data. The three SATPS measurements are obtained from SATPS satellites and digital altitude data is obtained from a terrain database. Three pseudorange equations and an altitude equation are used to determine the location of the SATPS receiver.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a satellite positioning system (SATPS) with four satellites and a SATPS receiver.

FIG. 2 is a block diagram of a SATPS receiver of FIG. 1 in communication with a server having digital terrain elevation data.

FIG. 3 is a diagram of bilinear interpolation employed with digital terrain elevation data of FIG. 2.

FIG. 4 is an illustration of the four orthometric heights identified in FIG. 3.

FIG. 5 is a flow chart of the steps for determining location with a SATPS receiver with digital terrain elevation data.

### DETAILED DESCRIPTION

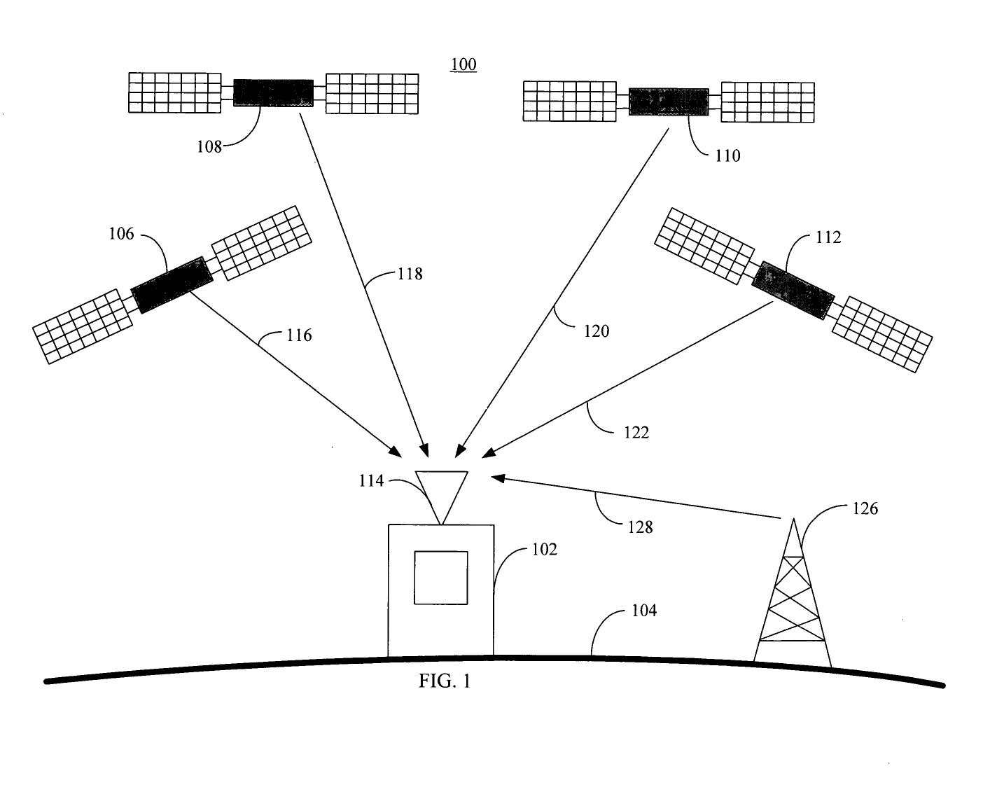

Turning first to FIG. 1, that figure illustrates a satellite position system (SATPS) 100 with a SATPS receiver 102 located on the Earth 104 in communication with four satellites 106, 108, 110, and 112. The SATPS receiver 102 via antenna 114 receives the SATPS spread spectrum signal 116, 118, 120, and 122 from the four satellites 106, 108, 110, and 112. The four SATPS spread spectrum signals 116, 118, 120, and 122 are transmitted at the same frequency. It is desirable for the SATPS receiver 102 to be receiving SATPS spread spectrum signals from as many satellites as possible, but to resolve the location, such as the x, y and z or latitude, longitude and altitude coordinates, at least three SATPS satellites in the SATPS system 100 must be in communication with the SATPS receiver 102 along with knowledge of the altitude of the receiver. Otherwise at least four SATPS satellites are required.

As an alternative to a SATPS spread spectrum signal from one of the satellites 106, 108, 110, or 112, an Earth based pseudollite 126 may transmit a SATPS spread spectrum signal 128 to the SATPS receiver 102. The SATPS receiver 102 still requires three spread spectrum signals and knowledge of altitude in order to determine the location of the SATPS receiver 102. In another implementation, a combined wireless device and SATPS receiver 102, such as in a cellular telephone, may receive altitude information from the pseudollite 126. In other implementations, the altitude information may be transmitted by a wireless data network such as a PCS system, Bluetooth system, private wireless data network, and within a television carrier wave to name but a few examples.

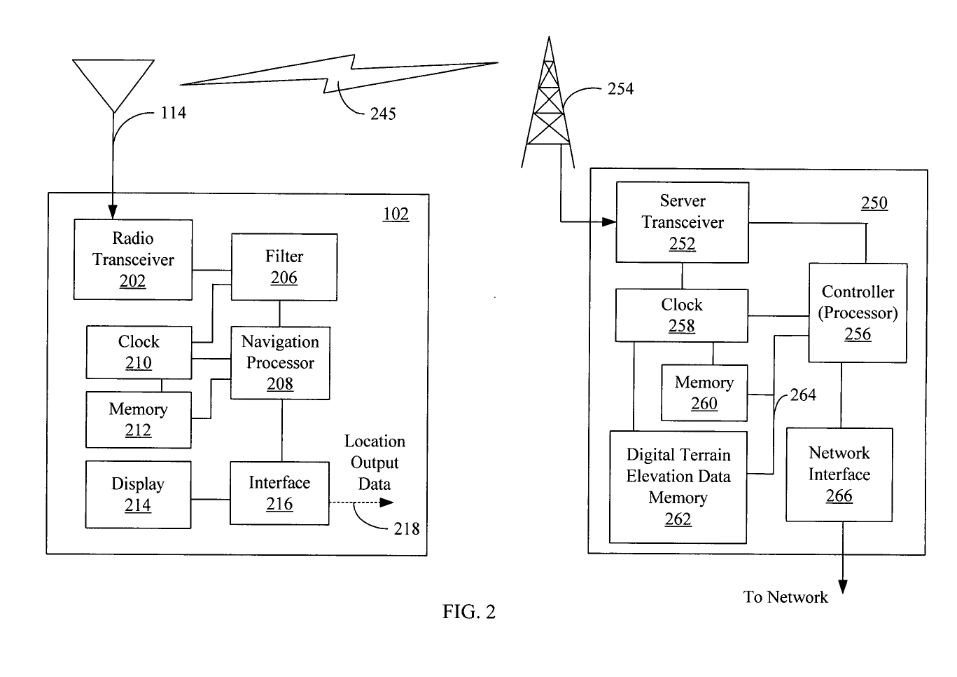

In FIG. 2, a block diagram of a SATPS receiver 102 of FIG. 1 in communication with a server 250 having digital terrain elevation data is shown. The SATPS receiver 102 acquires three SATPS spread spectrum signals, such as 116, 118 and 120 at the radio transceiver 202 via antenna 114. The SATPS spread spectrum signals are filtered by filter 206 under the control of navigation processor 208. The navigation processor 208 is coupled to the filter 206, clock 210, memory 212, and interface 216. The clock 210 may provide a plurality of clock signals from an oscillator to aid in the acquisition and processing of the SATPS spread spectrum signals and additionally provides timing for the navigation processor to transfer data to and from the filter 206, memory 212 and interface 216. The interface 216 may be coupled to a display 214 or the location output data may be outputted by interface 216.

The terrain database is not communicated from the server 250 to the SATPS receiver 102 in the current implantation. Rather the code phases are sent from the SATPS receiver 102 to the server 250. These code phases are converted to pseudo-range measurements in the server 250. The computation of position determination using the terrain database is not done in 208. Rather the computation is done in a processor of 250, such as controller 256.

If the SATPS receiver 102 is able to only receive or acquire three SATPS spread spectrum signal, such as 116, 118 and 120, the navigation processor 208 provides code phase information associated with the SATPS satellite signals to the server 250. The server 250 is shown in radio communication with the SATPS receiver 102 via server transceiver 252. The server 250 has a controller 256 connected to the server transceiver 252, clock 258, memory 260, digital terrain elevation data memory 262, and network interface 266. The clock may supply a plurality of timing signals for use by the server transceiver 252, the controller 256, the memory 260, and digital terrain elevation data memory 262. The controller 256 is connected to the memory 260 and digital terrain elevation data memory 262 by a data bus 264. The controller is also coupled to a network interface 266 that enables the server 250 to communication with a larger network. The network may be a PCS network, cellular network, PSTN network, Bluetooth network, or other known wired or wireless type of network.

The instructions that are executed by the controller 256 and control the operation of the server 250 may be contained in memory 260. The memory 260 may be any type of memory or storage device that accepts and stores machine-readable instructions. The memory 260 and digital terrain elevation data memory 262 are shown as being separate memory, but in other implementations, only one memory may be employed.

A request for processing with the use of digital terrain elevation data is received from the SATPS receiver 102 by the server transceiver 252 via antenna 254 and processed by the controller 256 under the control of machine-readable instructions in memory 260. The request from the SATPS receiver contains the code phases that are associated with the appropriate SATPS satellites 106, 108 and 110. The sever 250 may use the code phases from the SATPS receiver 102 to determine an estimated location. In other implementations, the request from the SATPS receiver 102 may contain an estimate of the location of the SATPS receiver 102. The controller 256 accesses the digital terrain elevation data memory 262 via data bus 264 to retrieve the digital terrain elevation data associated with the SATPS receiver's 102 estimated location. Examples of estimating the location of the SATPS receiver 102 at the server 250 include using either last known position of the SATPS receiver 102 or a triangulation scheme with directional antennas and known power setting of the radio transceiver 202.

The digital terrain elevation data from the digital terrain elevation data memory 262 is then processed by controller 256 to determine the location of the receiver 102. Upon determination of the SATPS receiver 102, a message containing that location is sent to the SATPS receiver 102 by the server transceiver 252 via antenna 254. In another implementation, the digital terrain elevation data from the digital terrain elevation data memory 262 is sent to the server transceiver 252 by controller 256 and via antenna 254 and then transmitted to the SATPS receiver 102 and the navigation processor 208 determines the location of the SATPS receiver 102 using the received digital terrain elevation data. In yet other implementations, the digital terrain elevation data may be contained at a common place within the network and the server 250 would access the common place via network interface 266.

Examples of digital terrain elevation data include the 1999 NIMA standard digital dataset (DTED) level 0 for commercial and public use. THE DTED provides a worldwide coverage and is a uniform matrix of terrain elevation values that provide basic quantitative data of terrain elevation, slope, andor surface roughness information. The DTED level 0 elevation post spacing is 30 arc seconds (approximately 1 kilometer). In addition to the discrete elevation file, separate binary files may provide the minimum, maximum, and mean elevation values computed in 30 arc second square areas. Another example of digital terrain elevation data is GTOPO30 with 30 arc seconds spacing. The digital elevation model was derived from several raster and vector sources of topographic information.

The memory 212, 260 and 262 may be RAM, DRAM, SDRAM, EEPROM, a combination of RAM, DRAM, SDRAM, and EEPROM, or any other type of readwriteable memory. One skilled in the art will appreciate that all or part of systems and methods consistent with the present invention may be stored on or read from other machine-readable media, for example, secondary storage devices such as hard disks, floppy disks, and CD-ROMs; a signal received from a network; or other forms of ROM or RAM either currently known or later developed. Further, although specific components of SATPS 100 are described, one skilled in the art will appreciate that a positioning system suitable for use with methods, systems, and articles of manufacture consistent with the present invention may contain additional or different components. For example, the navigation process 208 may be a microprocessor, microcontroller, application specific integrated circuit (“ASIC”), discrete or a combination of other types of circuits acting as a central processing unit.

The digital terrain elevation data is processed along with the code phases to determine the location of the SATPS receiver 102. The navigation processor 208 forms four simultaneous equations with data retrieved from three SATPS spread spectrum signals and the digital terrain elevation data. The fourth equation derived from the digital terrain elevation data is a result of polynomial (in 2 variables of latitude φ and longitude λ) surface fit to the appropriate terrain. To select the appropriate terrain from the digital terrain elevation data in the digital terrain elevation data memory 262 located in server 250, the SATPS spread spectrum signal 116, 118 and 120 from the three satellite 106, 108 and 110 are solved first for a fixed height “h”. The fixed value of “h” may be initially assigned to the average value of “h” in the neighborhood of the base station (unlike known approaches of using the previous values of “h”). Error in the fixed “h” is the absolute value of the difference between the average and the minimum or maximum value of “h”. With this information, the three SATPS satellite position solution with fixed “h” comes with an estimated error ellipse.

Grid points along the direction of the major and minor axes of the error ellipse are constructed by the navigation processor 208. The step sizes (along the directions of major and minor axes) are made proportional (1.5 times) to the magnitudes of the major and minor axes respectively. In other implementations, other step sizes may be employed along the major and minor axes. The center of the ellipse is the two-dimensional location determined from the three SATPS satellite signals 116, 118, 120 and the fixed “h”. In other implementations, the step size may be different. In the current implementation, 25 points are chosen in the grid. In other implementations, different number of points may be selected. Altitude values above the mean sea level at these points are obtained from the digital terrain elevation data (DTED) by indexing the four corner points in which the grid point resides and then using bilinear interpolation between the corner points. The obtained height values “H” are converted to World Geodetic Datum (WGS-84) “h” by adding the Geoid “N” separation derived from Earth Gravity Model (EGM-84) at the three SATPS satellite solution point determined from the three SATPS satellite signals 116, 118 and 120 and fixed “h”. Earth Gravity Model EGM-96 or other types of earth gravity models may be employed for determining Geoid “N” separations.

For the gird of 25 points of φ, λ and “h” a fourth order polynomial in φ and λ is found using the Least Square (LSQ) method, resulting in 15 coefficients needing to be determined. To handle ill conditioning the polynomial is found in new variables that represent a scaled deviation from the center point (the three SATPS satellite solution determined from the three SATPS satellite signals 116, 118 and 120 and fixed “h”). A numerical method of Q-R decomposition is used, such as the modified Gram-Schmidt procedure, which makes Q only orthogonal rather than orthonormal (to avoid square root operations).

The maximum deviation of the grid point altitude from the surface fit is the error associated with this forth polynomial equation. If this error exceeds some error threshold, then the polynomial fit is rejected and more than one polynomial surface fit is required. In other implementations, different error thresholds may be employed. If the error threshold has not been exceeded, then only one polynomial surface fit is required.

The three polynomial equations associated with the three SATPS satellite signals 116, 118 and 120, and the fourth polynomial equation obtained from the terrain elevation data are solved for curvilinear coordinates of φ, λ, H, and clock bias rather than using Earth Center Earth Fixed (ECEF) coordinates. The ECEF coordinate formulation is retained and changed from ECEF to WGS 84 curvilinear coordinates by the navigation processor 208 working with the corresponding Jacobian which is the coordinate transformation from differential ECEF coordinates to differential curvilinear coordinates. If there is a convergence then the converged solution is accepted if it belongs to the region of polynomial surface-fit.

Upon the location of the SATPS receiver 102 being determined and received by the SATPS receiver 102, the navigation processor 208, via interface 216 displays the location on display 214. In other implementations, the digital terrain elevation memory 262 may be contained within digital terrain elevation data memory located within the SATPS receiver 102 as separate memory or may be within memory 212. In yet other implementations, the SATPS receiver 102 is only a module of a larger device, such as a cellular phone or other wireless device where the location data is output via location data output 218 to another module within the device.

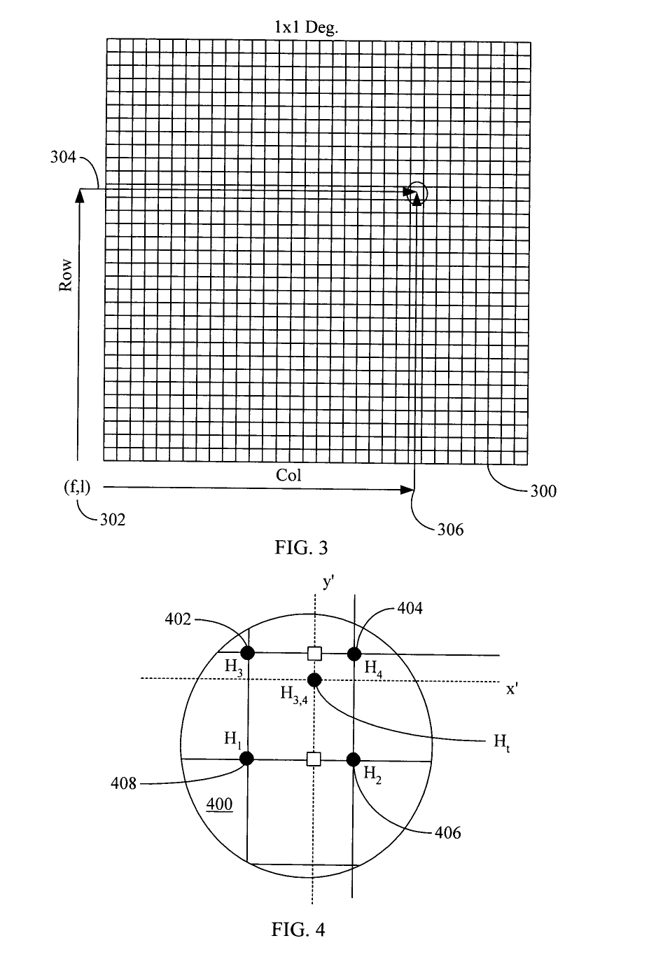

In FIG. 3, a diagram of bilinear interpolation employed with digital terrain elevation data of FIG. 2 is shown. A table 300 of digital terrain elevation data of 1×1 degree increments is accessed from the South West Corner 302 (φᵣ, λᵣ) by row 304 and column 306. Given a latitude, φᵤ and longitude, λᵤ, the nearest South-West corner 302 of the table 300(DTED data file) is found and used as a reference to find an index in table 300. This index is used to retrieve the H. In other implementations, a different position or corner of the available digital terrain elevation data and a data type other than DTED may be used with appropriate changes to the equations. The equations are:
y=λᵤ−λᵣ
where:
λᵣ Reference Longitude for South West Corner of an available DTED data file.
λᵤ AprioriUser Longitude.
y Difference in degrees (longitude).
   x=φᵤ−φᵣ
   where:
φᵣ Reference Latitude for South West Corner of an available DTED data file.
φᵤ User Latitude.
x Difference in degrees (latitude)

$$brow = [ \frac{y * 3600}{Δ {λ}_{spacing}} ]$$

Where:
Δλ_{spacing} DTED LEVEL 0 Grid Spacing of 30″ Arc Seconds.
y Difference in degrees.
brow Integer Row value within DTED data file in the range [0, 119].

$$bcol = [ \frac{x * 3600}{Δ {ϕ}_{spacing}} ]$$

Where:
Δφ_{spacing} DTED LEVEL 0 Grid Spacing of 30″ Arc Seconds.
x Difference in degrees.
bcol Integer Column value within DTED data file in the range [0, 119].

The values of brow 304 and bcol 306 are used to find the index in the data file and then this index enables access to the altitude value H₃, latitude φ₃ and longitude λ₃.

Turning to FIG. 4, a diagram 400 of the four Orthometric heights identified in FIG. 3 is shown. The Orthmetric heights H₁408, H₂ 406 and H₄ 404 are obtained from (brow+1) and bcol, (brow+1) and (bcol+1), and brow and (bcol+1) respectively. Then, H at φᵤ and λᵤ is obtained by:

$${x}^{′} = \frac{( {ϕ}_{u} - {ϕ}_{3} ) 3600}{( {Δϕ}_{spacing} - bcol )}$$

where:
x′ Weighted Ratio from reference Latitude, Latitude grid spacing and DTED column location.

$${y}^{′} = \frac{( {λ}_{u} - {λ}_{3} ) 3600}{( {Δλ}_{spacing} - brow )}$$

where:
y′ Weighted Ratio from userreference Longitude, grid spacing and DTED column location.
   Hᵢ=H₁+(H₂−H₁)·x′+(H₄−H₁)·y′+(H₁+H₃−H₂−H₄)·x′•y′
   where:
Hᵢ, . . . , H₄, represent 4 Orthometric heights in a given searched row and column result.
Hᵢ The interpolated Orthometric height and 25 of these points are determined.

To estimate the 25 points of “h” requires the estimation of the Geoid N from the EGM-84 model as a function of φᵤ and λᵤ, the processing is the same as determining H from the DTED. Once N is estimated, a linear shift by N is used to determine “h”.

The LSQ solution from the three satellite signal equations (pseudoranges) and average “h” is determined by solving:
ρ₁=\sqrt{(s₁ₓ−pₓ)²+(s_{1y}−p_{y})²+(s_{1z}−p_{z})²}·(1−m₁)+b
ρ₂=\sqrt{(s₂ₓ−pₓ)²+(s_{2y}−p_{y})²+(s_{2z}−p_{z})²}·(1−m₂)+b
ρ₃=\sqrt{(s₃ₓ−pₓ)²+(s_{3y}−p_{y})²+(s_{3z}−p_{z})²}·(1−m₃)+b
h=\sqrt{(p′ₓ−pₓ)²+(p′_{y}−p_{y})²+(p′_{z}−p_{z})²}·sgn (h)
where (s₁ₓ, s_{1y}, s_{1z}) are the ECEF coordinates of antenna phase center of a SATPS satellite “i” at the receive time, (pₓ, p_{y}, p_{z}) are the ECEF coordinates of the antenna 114 phase center of the SATPS receiver 102, “b” is common offset in pseudorange measurements, mᵢ is satellite mean motion correction term (given below), (p′ₓ, p′_{y}, p′_{z}) are ECEF coordinates of projection of (pₓ, p_{y}, p_{z}) on the WGS-84 ellipsoid, ρᵢ is the measured pseudorange for SATPS satellite i, h is the height above WGS-84 ellipsoid and sgn(h)=1 if h>0, sgn(h)=−1 if h<0, and it is undefined when h=0 (here the equation itself reduces to an identity but the differential version of the equation is still defined). The “h” is given by the average “h” as obtained previously. The receive time is assumed to have errors of less than approximately 10 ms so that the SATPS satellites 106, 108 and 110 positions as computed from the ephemeris have good accuracy. The mean motion correction term, mᵢ is given as:

$${m}_{i} = \frac{1}{c} \cdot ( {v}_{i} + ω \times {s}_{i} ) ° ( {s}_{i} - p )$$

where x denotes vector cross product, ∘ denotes vector dot product, vᵢ is the velocity vector of SATPS satellite i, sᵢ is the position vector of SATPS satellite i, ω is the Earth rotation vector and p is SATPS receiver 102 position vector, the x, y, and z coordinates of all vectors are in ECEF and all except ω correspond to the antenna 114 phase centers.

If (p*ₓ, p*_{y}, p*_{z}) are the ECEF coordinates of the reference or approximate position which serves as the initial guess for (pₓ, p_{y}, p_{z}) and let b* be the initial guess for pseudorange offset. Expanding the left hand side to a first order approximation using Taylor series gives the following equations:

$$[ \begin{matrix}- {l}_{1 x} & - {l}_{1 y} & - {l}_{1 z} & 1 \\ - {l}_{2 x} & - {l}_{2 y} & - {l}_{2 z} & 1 \\ - {l}_{3 x} & - {l}_{3 y} & - {l}_{3 z} & 1 \\ - {d}_{x} & - {d}_{y} & - {d}_{z} & 0\end{matrix} ] \cdot [ \begin{matrix}Δ {p}_{x} \\ Δ {p}_{y} \\ Δ {p}_{z} \\ Δ b\end{matrix} ] = [ \begin{matrix}Δ {ρ}_{1} \\ {Δρ}_{2} \\ Δ {ρ}_{3} \\ Δ h\end{matrix} ]$$

Where, lᵢ is line of sight unit vector pointing from receiver to SATPS satellite i and d is down direction unit vector pointing along the downward normal to the WGS-84 ellipsoid, Δpₓ, Δp_{y} and Δp_{z} are differential position coordinates, Δb is differential pseudorange offset, Δρ₁, Δρ₂ and Δρ₃ are differential pseudoranges, and Δh is differential h. The line of sight unit vector is given by:

$${l}_{i} = \frac{1}{\sqrt{{( {s}_{ix} - {p}_{x}^{*} )}^{2} + {( {s}_{iy} - {p}_{y}^{*} )}^{2} + {( {s}_{iz} - {p}_{z}^{*} )}^{2}}} \cdot ( {s}_{i} - {p}^{*} )$$

the down direction unit vector is given by:

$$d = [ \begin{matrix}- cos {λ}^{*} \cdot cos {ϕ}^{*} \\ - sin {λ}^{*} \cdot cos {ϕ}^{*} \\ - sin {ϕ}^{*}\end{matrix} ]$$

where (φ*, λ*, h*) are the WGS-84 geodetic coordinates of p*.
Δρᵢ=ρᵢ−ρᵢ^{*}
where p^{*}ᵢ are obtained from the right hand side of the equations of pseudoranges and average “h” and
Δh=h−h^{*}

The Taylor series equation is solved for Δpₓ, Δp_{y}, Δ_{z}, and Δb. Then the estimates of position and clock bias are updated as:

$$[ \begin{matrix} {\hat{p}}_{x} \\ {\hat{p}}_{y} \\ {\hat{p}}_{z} \\ \hat{b}\end{matrix} ] = [ \begin{matrix} {p}_{x}^{*} \\ {p}_{y}^{*} \\ {p}_{z}^{*} \\ {b}^{*}\end{matrix} ] + [ \begin{matrix}Δ {p}_{x} \\ Δ {p}_{y} \\ Δ {p}_{z} \\ Δ b\end{matrix} ]$$

This is the Newton-Raphson update. Next, the initial guess is replaced by the new estimate as:

$$[ \begin{matrix} {p}_{x}^{*} \\ {p}_{y}^{*} \\ {p}_{z}^{*} \\ {b}^{*}\end{matrix} ] = [ \begin{matrix} {\hat{p}}_{x} \\ {\hat{p}}_{y} \\ {\hat{p}}_{z} \\ \hat{b}\end{matrix} ]$$

and the iterations are continued until Δpₓ, Δp_{y}, Δp_{z}, and Δb become less than the threshold.

With the grid of 25 points a two-dimensional polynomial is set up in the auxiliary variables \overline{φ} and \overline{λ} which are given in terms of WGS-84 φ and λ as:
\overline{φ}=q·(φ−φ_{c})
\overline{λ}=q·(λ−λ_{c})
where q is a scale factor (chosen as 100), and φ_{c} and λ_{c} respectively are the WGS-84 latitude and longitude in degrees of the solution obtained previously. The LSQ polynomial surface fit equation is given by:
h=p(\overline{φ},\overline{λ})=c₀·\overline{φ}+c₁·\overline{λ}+c₂·\overline{φ}²+c₃·\overline{φ}·\overline{λ}+c₄·\overline{λ}²+ . . . +cₘ₋₂·\overline{λ}ⁿ+cₘ₋₁

The total number of coefficients, m, for degree, n are given by the recursive formula: m(n)=m(n−1)+(n+1) with m(0)=1. For degree, n=4, m=15. The coefficients, cᵢ, where i=l, . . . , m are obtained by solving the following linear equation using least square method.

$$[ \begin{matrix}\overline{{ϕ}_{1}} & \overline{{λ}_{1}} & \overline{{ϕ}_{1}^{2}} & {ϕ}_{1} \cdot & \overline{{λ}_{1}} & \overline{{λ}_{1}^{2}} & ⋯ & \overline{{λ}_{1}^{n}} & 1 \\ \overline{{ϕ}_{2}} & \overline{{λ}_{2}} & \overline{{ϕ}_{2}^{2}} & {ϕ}_{2} \cdot & \overline{{λ}_{2}} & \overline{{λ}_{2}^{2}} & ⋯ & \overline{{λ}_{2}^{n}} & 1 \\ ⋮ & ⋮ & ⋮ & & ⋮ & ⋮ & ⋯ & ⋮ ⋮ & \\ \overline{{ϕ}_{r}} & \overline{{λ}_{r}} & \overline{{ϕ}_{r}^{2}} & {ϕ}_{r} \cdot & \overline{{λ}_{r}} & \overline{{λ}_{r}^{2}} & ⋯ & \overline{{λ}_{r}^{n}} & 1\end{matrix} ] \cdot [ \begin{matrix}{c}_{0} \\ {c}_{1} \\ {c}_{2} \\ {c}_{3} \\ {c}_{4} \\ ⋮ \\ {c}_{m - 2} \\ {c}_{m - 1}\end{matrix} ] = [ \begin{matrix}{h}_{1} \\ {h}_{2} \\ ⋮ \\ {h}_{r}\end{matrix} ]$$

where the subscript i (except on the coefficient) represents i-th point of the terrain. The points are chosen as follows: The center point (as given by φ_{c}, λ_{c}, and h_{c}) is the point that corresponds to the solution previously obtained. This solution also comes with horizontal error ellipse parameters of the semi-major axis, aₑ, the semi-minor axis, bₑ, and the angle the semi-major axis subtends with the east direction θ_{c}, measured anti-clockwise positive. This information is used to create a grid of points as:

$$[ \begin{matrix}Δ n \\ Δ e\end{matrix} ] = [ \begin{matrix}cos {θ}_{e} & - sin {θ}_{e} \\ sin {θ}_{e} & cos {θ}_{e}\end{matrix} ] \cdot [ \begin{matrix}i \cdot Δ {a}_{e} \\ j \cdot Δ {b}_{e}\end{matrix} ]$$

$$i = - k , \begin{matrix}… k & j = - k , … , k\end{matrix}$$

$$and \\ [ \begin{matrix}{ϕ}_{i} \\ {λ}_{j}\end{matrix} ] = [ \begin{matrix}{ϕ}_{c} \\ {λ}_{c}\end{matrix} ] \cdot [ \begin{matrix}Δ n / ( ( {N}_{c} + h ) cos {ϕ}_{c} ) \\ Δ e / ( {M}_{c} + {h}_{c} )\end{matrix} ]$$

where,

$${M}_{c} = \frac{a ( 1 - {e}^{2} )}{{( 1 - {e}^{2} {sin}^{2} {ϕ}_{c} )}^{3 / 2}} and {N}_{c} = \frac{a}{\sqrt{1 - {e}^{2} {sin}^{2} {ϕ}_{c}}}$$

where a is the semi-major axis of the WGS-84 ellipsoid and e is its eccentricity. Δaₑ is chosen to be 1.5aₑ and Δbₑ is chosen to be 1.5_{b}_{ₑ}.

The value of k is chosen to be 2, giving total number of points, r=25 and giving a coverage 3-sigma area along the semi-major and semi-minor axes. The degree of the polynomial n, is chosen as 4^{th} order giving number of coefficients, m=15. The system of equations therefore is 25 equations and 15 unknowns and is solved with the help of modified Gram-Schmidt procedure.

The LSQ polynomial surface fit equation in the usual matrix notation is A·C=H and the objective in least squares solution is to minimize (A·C−H)^{T}·W·(A·C−H), where W is positive definite weighting matrix. The optimum solution is obtained by solving the set A^{T}·W·A·C=A^{T}·W·H. This set can be written as B^{T}·B·C=B^{T}·Γ·H, by using the decomposition W=Γ^{T}·Γ and using B=A·Γ. This new set can further be written as R·C=D⁻¹·Q^{T}·H, where B is decomposed as B=Q·R, with R unit upper triangular (diagonal elements of R are all ones and lower diagonals are all zeros) and such that Q^{T}·Q=D, D being a diagonal matrix. The upper triangular set of equations can be solved using back-substitution method. In the above, two decompositions are used. The first is: W=Γ^{T}·Γ. This can be done using Cholesky's method. Usually, W is diagonal and then so is Γ and it can be obtained simply by taking square roots of the diagonal elements of W. Even simpler case is when W=I, where I is identity matrix and then Γ=I as well. This equal weighting is used in the solution. The second decomposition is B=Q·R. This decomposition can be obtained by modified Gram-Schmidt method that gives Q, R and D by avoiding square root operations since Q is only orthogonal (not orthonormal).

The equations from the three pseudoranges and polynomial surface equation are solved by LSQ solution method as described previously (using fixed “h”) with two exceptions. The last (fourth) equation (fixed “h”) is replaced by altitude equation as a polynomial in φ and λ. With this change, it is convenient to consider the first three equations in the unknowns of φ, λ, and h, rather than in the ECEF frame. So, the equations are written as:

$$\begin{matrix}{ρ}_{1} = \sqrt{{( {s}_{1 x} - {p}_{x} ( ϕ , λ , h ) )}^{2} + {( {s}_{1 y} - {p}_{y} ( ϕ , λ , h ) )}^{2} + {( {s}_{1 z} - {p}_{z} ( ϕ , λ , h ) )}^{2}} \cdot ( 1 - {m}_{1} ) + b \\ {ρ}_{2} = \sqrt{{( {s}_{2 x} - {p}_{x} ( ϕ , λ , h ) )}^{2} + {( {s}_{2 y} - {p}_{y} ( ϕ , λ , h ) )}^{2} + {( {s}_{2 z} - {p}_{z} ( ϕ , λ , h ) )}^{2}} \cdot ( 1 - {m}_{2} ) + b \\ {ρ}_{3} = \sqrt{{( {s}_{3 x} - {p}_{x} ( ϕ , λ , h ) )}^{2} + {( {s}_{3 y} - {p}_{y} ( ϕ , λ , h ) )}^{2} + {( {s}_{3 z} - {p}_{z} ( ϕ , λ , h ) )}^{2}} \cdot ( 1 - {m}_{3} ) + b \\ h = {c}_{o} \cdot \overline{ϕ} ( ϕ ) + {c}_{1} \cdot \overline{λ} ( λ ) + {c}_{2} \cdot {ϕ ( ϕ )}^{2} + {c}_{3} \cdot {\overline{ϕ} ( ϕ )}^{2} \cdot \overline{λ} λ + {C}_{4} \cdot {\overline{λ} ( λ )}^{2} + … + {c}_{m - 2} \cdot {\overline{λ} ( λ )}^{n} + {c}_{m - 1}\end{matrix}$$

where:
pₓ=(N+h)·cos φ·cos λ
p_{y}=(N+h)·cos φ·sin λ
p_{z}=((1−e²)·N+h)·sin φ

The set of equations is solved using Newton-Raphson method. This time the initial guess is given by (φ_{c}, λ_{c}, h_{c}) which is obtained previously. Further let b_{c} be the initial guess for the pseudorange offset, taken again from the previous solution. Expanding the left side of the polynomial surface equations around the initial guess to a first order approximation using Taylor series and solving for Δφ, Δλ, Δh, and Δb and then applying the same procedure as for the fixed “h” LSQ solution results in a sought solution.

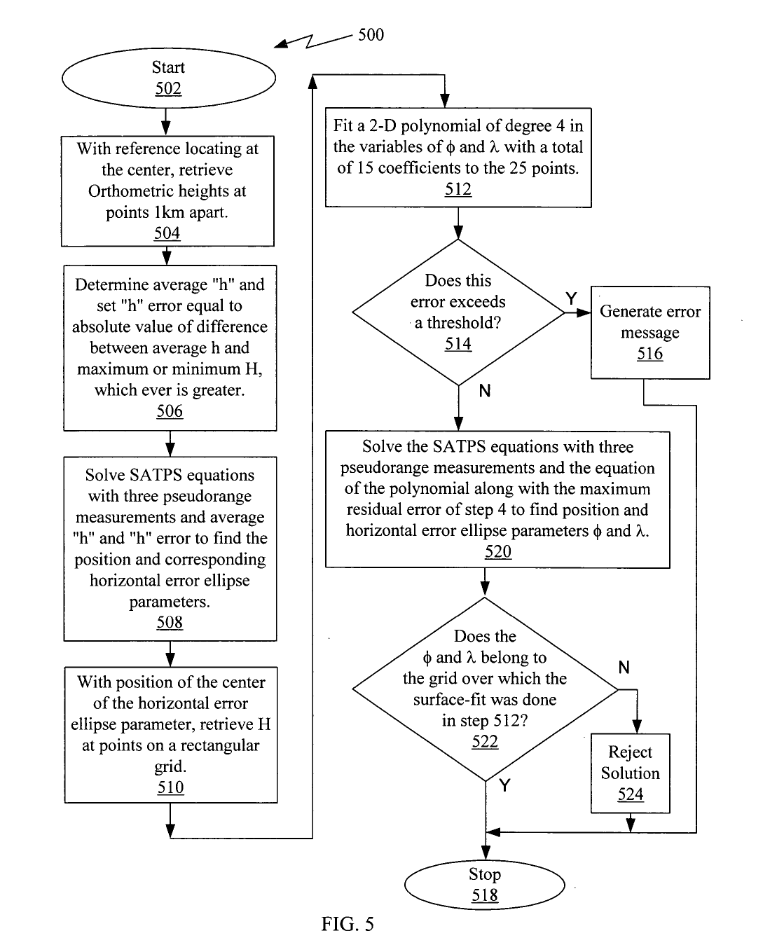

In FIG. 5, a flow chart 500 of the steps for determining location with a SATPS receiver with digital terrain elevation data is shown. The SATPS receiver 102 starts 502 by receiving three SATPS satellite spread spectrum signal 116, 118 and 120 and digital terrain elevation data from digital terrain elevation data memory 262 in server 250. Upon a reference location being determined, the orthometric heights at points 1 km apart in the easting and northing direction are retrieved with the reference location at the center 504. A total of (2·N+1)² points are considered on a grid of (2·N+1)×(2·N+1) points. The orthometric “H” coordinates are converted to WGS 84 “h”. The average “h” is determined and the “h” error equal to absolute value of the difference between the average “h” and the maximum or minimum “h” (whichever is the greater).

The SATPS pseudorange measurements, average “h” and the “h” error in step 506 are used to find the position and corresponding horizontal error ellipse parameters (508). Then, with the position determined in step 508 at the center, “H” at points on a rectangular grid are constructed along the major and minor axes of the ellipse in 510. The interval between successive points along the major axis is 1.5 times the major-axis magnitude and along the minor axis, it is equal to 1.5 times the minor-axis magnitude. A total of 25 points are considered on a grid of 5×5 points.

A two-dimensional polynomial of degree 4 is fit in the variables of φ and λ with 15 coefficients to the 25 points previously obtained in step 510. The maximum residual error for the polynomial fit is determined and if the error exceeds a predetermined threshold in step 514, then an error message 516 is generated and processing is complete 518. Otherwise, if the predetermined threshold is not exceeded in step 514, then the SATPS pseudorange equations and the equation of the polynomial along with the maximum residual error of step 512 to determine the position 520. In step 522, a check is made to determine if the φ and λ obtained in step 520 belong to the grid over which the surface-fit was done in step 512. If yes then the solution is accepted and processing is complete 518, otherwise the solution is rejected 524.

The processing has been shown as being stopped 518 for illustrative purposes. In practice, processing may continue and start at step 502 again, enter an idle state until instructed to process new location information, or execute other plurality of machine-readable instructions that are stored in some type of memory. The steps previously described, my occur with additional steps or with steps combined.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

1. A satellite positioning receiver capable of receipt of an at least three positioning signals, comprising:
a navigation processor that processes the at least three positioning signals and determines an at least three code phases; and
a location determined from initial digital terrain elevation data used to calculate a solution with the at least three code phases and an altitude equation derived from the initial digital terrain elevation data.

2. The satellite positioning receiver of claim 1, where the solution further includes:
a horizontal error ellipse parameter in the altitude equation that form an error ellipse having a major axis and a minor axis that corresponds to the altitude error;
a plurality of points along the major axis and the minor axis that form a grid of grid points; and
a memory that contains digital terrain elevation data at the grid points.

3. The satellite positioning receiver of claim 2, includes:
a server that receives a plurality of satellite code phases where each of the satellite code phases is associated with a satellite position system signal over a wireless network; and
a controller in the server accesses the initial digital terrain data in order to determine a solution.

4. The satellite positioning receiver of claim 2, where the initial digital terrain elevation data is retrieved from the memory in response to receipt of a signal other than the at least three positioning signal.

5. The satellite positioning receiver of claim 2, wherein the digital terrain elevation data in the memory is NIMA (DTED) level 0 digital mean elevation data.

6. The satellite positioning receiver of claim 2, where the digital terrain elevation data in the memory is GTOPO30 Global Elevation data.

7. The satellite positioning receiver of claim 2, further includes:
a maximum residual error in a polynomial surface fit over the grid points calculated by the navigation processor is below a predetermined threshold.

8. The satellite positioning receiver of claim 7, where the predetermined threshold is 100 meters.

9. The satellite positioning receiver of claim 1, where the navigation processor is a processor located in a server.

10. A method of determining the location of a receiver in recipient of at least three positioning signals, comprising:
identifying a reference location with the at least three positioning signals;
retrieving an initial height;
determining an average height along with an average height error from the initial height;
deriving at least three simultaneous equations associated with the at least three positioning signals;
solving the at least three simultaneous equations with the average height and the average height error that results in a position and a corresponding horizontal error ellipse;
fitting a two-dimensional polynomial to the corresponding horizontal error ellipse; and
solving the at least three simultaneous equations and the two dimension polynomial that results in an altitude of the satellite positioning receiver.

11. The method of claim 10, where determining an average height further includes:
identifying one of a minimum height and a maximum height; and
setting the height error equal to the absolute value of the difference between the one of the minimum height and the maximum height and the average height.

12. The method of claim 10, where retrieving an initial height further includes:
transmitting a plurality of code phases to a server where each of the code phases is associated with each of the positioning signal; and
accessing digital terrain data stored in a memory to retrieve the initial height.

13. The method of claim 12, wherein the wireless network is a cellular communication network.

14. The method of claim 10, where retrieving an initial height further includes:
receiving the initial height from a memory located within the satellite positioning receiver.

15. The method of claim 10, further include:
acquiring another height using variables from the two dimensional polynomial; and
comparing the difference between the other height and altitude to a predetermined threshold.

16. The method of claim 15, where the predetermined threshold is 100 meters.

17. The method of claim 10, where the receiver is located in a server.

18. A satellite positioning receiver apparatus in recipient of at least three positioning signals, comprising:
means for identifying a reference location with the at least three positioning signals;
means for retrieving an initial height;
means for determining an average height along with an average height error from the initial height;
means for deriving at least three simultaneous equations associated with the at least three positioning signals;
means for solving the at least three simultaneous equations with the average height and the average height error that results in a position and a corresponding horizontal error ellipse;
means for fitting a two-dimensional polynomial to the corresponding horizontal error ellipse; and
means for solving the at least three simultaneous equations and the two dimension polynomial that results in an altitude of the satellite positioning receiver.

19. The apparatus of claim 18, wherein the determining an average height means further includes:
means for identifying one of a minimum height and a maximum height; and
means for setting the height error equal to the absolute value of the difference between the one of the minimum height and the maximum height and the average height.

20. The apparatus of claim 18, wherein the means for retrieving an initial height further includes:
means for receiving the initial height from a server located in a wireless network.

21. The apparatus of claim 20, wherein the wireless network is a cellular communication network.

22. The apparatus of claim 18, wherein the means for retrieving an initial height further includes:
means for receiving the initial height from a memory located within the satellite positioning receiver.

23. The apparatus of claim 18, further include:
means for acquiring another height using variables from the two dimensional polynomial; and
means for comparing the difference between the other height and altitude to a predetermined threshold.

24. The apparatus of claim 23, where the predetermined threshold is 100 meters.

25. A machine-readable signal bearing medium for satellite positioning receiver apparatus containing a plurality of machine-readable signals, comprising:
means for identifying a reference location upon receipt of at least three positioning signals;
means for retrieving an initial height;
means for determining an average height along with an average height error from the initial height;
means for deriving at least three simultaneous equations associated with the at least three positioning signals;
means for solving the at least three simultaneous equations with the average height and the average height error that results in a position and a corresponding horizontal error ellipse;
means for fitting a two-dimensional polynomial to the corresponding horizontal error ellipse; and
means for solving the at least three simultaneous equations and the two dimension polynomial that results in an altitude of the satellite positioning receiver.

26. The machine-readable signal bearing medium of claim 25, wherein the determining an average height means further includes:
means for identifying one of a minimum height and a maximum height; and
means for setting the height error equal to the absolute value of the difference between the one of the minimum height and the maximum height and the average height.

27. The machine-readable signal bearing medium of claim 25, wherein the means for retrieving an initial height further includes:
means for receiving the initial height from a server located in a wireless network.

28. The machine-readable signal bearing medium of claim 27, wherein the wireless network is a cellular communication network.

29. The machine-readable signal bearing medium of claim 25, wherein the means for retrieving an initial height further includes:
means for receiving the initial height from a memory.

30. The machine-readable signal bearing medium of claim 25, further include:
means for acquiring another height using variables from the two dimensional polynomial; and
means for comparing the difference between the other height and altitude to a predetermined threshold.

31. The machine-readable signal bearing medium of claim 30, where the predetermined threshold is 100 meters.

32. A server, comprising:
a transceiver that receives a plurality of satellite code phases;
a memory with digital terrain elevation data; and
a controller that processes the plurality of code phases and accesses the digital terrain data in memory with an initial height to determine a location indicated by the plurality of satellite codes and the digital terrain data.

33. The server of claim 34, further includes:
a message containing the location data sent from the transceiver.

34. The server of claim 32, including:
a horizontal error ellipse parameter in an altitude equation that form an error ellipse having a major axis and a minor axis that corresponds to an altitude error about the initial height; and
a plurality of points along the major axis and the minor axis that form a grid of grid points that the controller accesses the digital terrain elevation data in memory at the grid points.
